(19) United States
(12) Patent Application Publication
(10) Pub. No.: US 2017/0206477 A1
(43) Pub. Date: Jul. 20, 2017

(54) SYSTEM AND METHOD FOR HEALTH MONITORING OF BUSINESS PROCESSES AND SYSTEMS

(71) Applicant: AMERICAN EXPRESS TRAVEL RELATED SERVICES COMPANY, INC., New York, NY (US)

(72) Inventors: John Almasan, Phoenix, AZ (US); Rebecca Henry, Phoenix, AZ (US); Matthew H. Payton, Phoenix, AZ (US)

(73) Assignee: AMERICAN EXPRESS TRAVEL RELATED SERVICES COMPANY, INC., New York, NY (US)

(21) Appl. No.: 15/001,482

(22) Filed: Jan. 20, 2016

(51) Int. Cl. G06Q 10/06

(52) U.S. Cl. CPC G06Q 10/0633

(57) ABSTRACT

A system to holistically provide continuous health monitoring of business processes and systems is disclosed. The system may identify a business process for health monitoring. The system may monitor and retrieve data from data sources relating to the business process. The system may generate analytic models and compare the retrieved data against the analytic models, in order to determine the health of the business process. The system may further generate health monitoring reports and alerts based on the health of the business process.

### FIELD

The disclosure generally relates to business process monitoring, and more specifically, to systems and methods for the health monitoring of end-to-end business processes.

### BACKGROUND

Business processes may run across multiple platforms and multiple applications in a system. Currently, tools exist to assist in both transactional load balancing, as well as single application event tracking. However, these tools may only audit and monitor short timeframes and segments of the processes, and these tools may not be running in real-time. The tools may work by monitoring only the end result (e.g., whether the process was successful) and may not monitor the process end-to-end. Moreover, the tools may only monitor based on casualty and not on predictive analytics. As such, there is an increased need for systems and methods to provide continuous, real-time end-to-end health monitoring of critical business processes.

### SUMMARY

In various embodiments, systems, methods, and articles of manufacture (collectively, the “system”) for the health monitoring of business processes and systems are disclosed. The system may comprise identifying a health monitoring task by a processor in electronic communication with a health monitoring module. The health monitoring task may specify a data source. The system may monitor the data source by the processor and via the health monitoring module. The system may retrieve a health monitoring data from the data source. The system may generate a data analytic model based on the health monitoring task. The system may compare the data analytic model to the health monitoring data to determine the health of the health monitoring task.

The system may comprise transmitting the health monitoring data to a health monitoring database. The system may also comprise cataloging, via a data catalog module, the health monitoring data in the health monitoring database. The system may comprise generating a health monitoring alert in response to the comparison of the data analytic model to the health monitoring data yielding an anomaly. The system may also comprise certifying the health monitoring task by comparing the health monitoring report to the health monitoring task. The system may further comprise transmitting the health monitoring report to the health analysis module.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1A is a block diagram illustrating various system components of a system for health monitoring of business processes and systems, in accordance with various embodiments;

FIG. 1B is a block diagram illustrating various sub-system components of a system for health monitoring of business processes and systems, in accordance with various embodiments;

FIG. 2 illustrates a process flow for monitoring a health monitoring task, in accordance with various embodiments;

FIG. 3 illustrates a process flow for analyzing health monitoring data, in accordance with various embodiments; and

FIG. 4 illustrates a process flow for health monitoring of systems and applications, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the system may be configured to holistically provide partially or fully continuous health monitoring to a business process and/or system. Instead of focusing solely on the end result of a process (e.g., whether the process was successful), the system may partially or fully monitor the business process end-to-end (or any portion thereof). Monitoring the business process end-to-end may provide better and concise health monitoring of the business process. The system may monitor both “big” data (i.e., all-time historical data) and “wide” data (i.e., data from an increased number of related variables). This use of data may produce much more precise and accurate monitoring, and allow for predictive analytics instead of casualty. Moreover, the system may promote awareness and continuous improvements by enabling swift stoppages to system health problems, and may work to reduce an entity's exposure due to business, system, and/or technological failures. The system may further be configured to generate an alert in response to a health monitoring failure being detected.

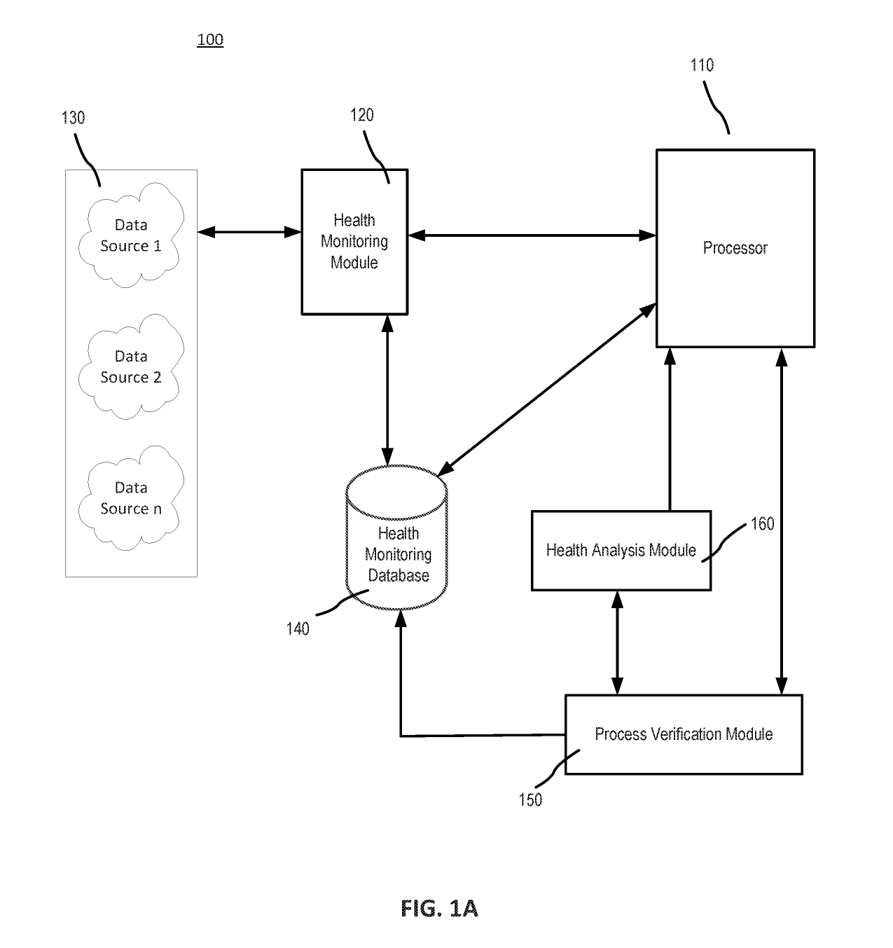

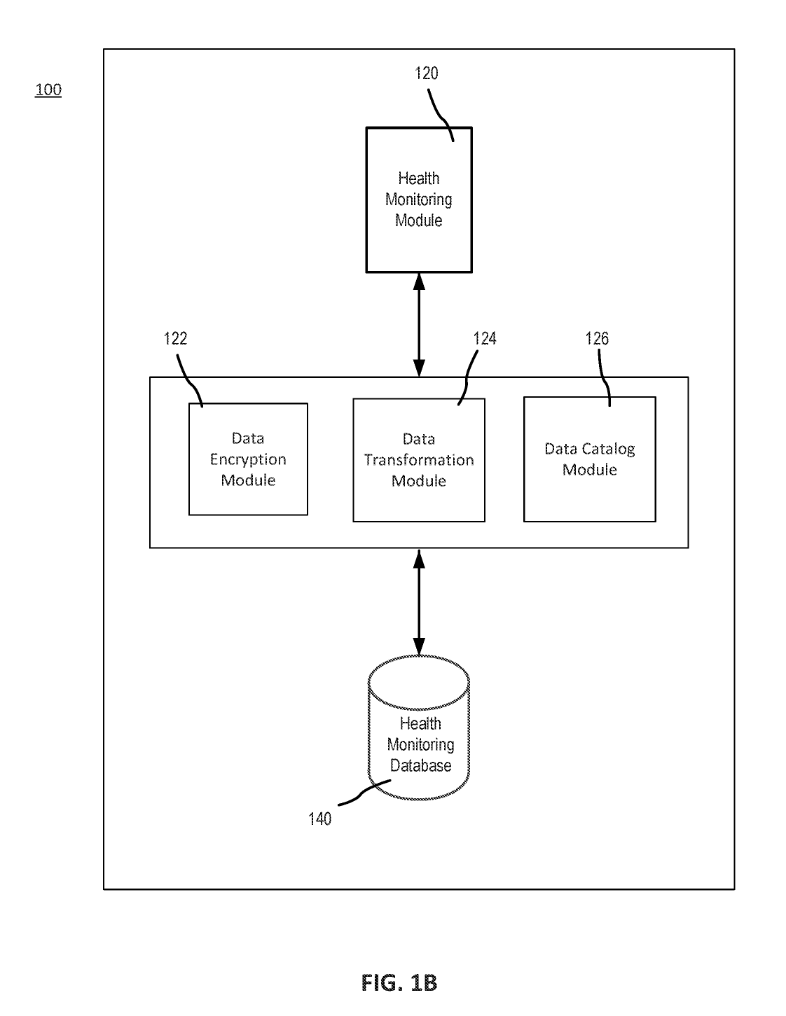

In various embodiments, and with reference to FIG. 1A, system 100 may comprise a processor 110, a health monitoring module 120, a data source 130, a health monitoring database 140, a health analysis module 160, and/or a process verification module 150. Processor 110 may be configured as a central hub for the health monitoring of business processes. Processor 110 may be in electronic and/or operative communication with health monitoring module 120, health monitoring database 140, health analysis module 160, and/or process verification module 150. Processor 110 may be in electronic and/or operative communication using any suitable method discussed in this disclosure or known in the art.

In various embodiments, processor 110 may be instructed to monitor the health of a business process. The business process may comprise a health monitoring task. In this regard, the health monitoring task may comprise the process, application, and/or task that may be monitored by the system. The business process may be identified by an entity. For example, an entity may wish to implement the system to monitor the health of business processes that are highly problematic and/or have a high cost associated to a failure (e.g., a business process having regulatory compliance standards). As a further example, the entity may comprise a financial institution. The financial institution may wish to monitor the health of various financial transaction processes. For example, the financial institution may wish to monitor the business process of posting merchant credits to a financial account. The financial institution may instruct the processor to monitor the health of that process. In various embodiments, processor 110 may also be instructed to monitor the health of all business processes, with no one (or several) business processes and/or health monitoring tasks individually identified.

In various embodiments, processor 110 may also be configured to analyze and review health monitoring data, and to provide analytical capabilities. The health monitoring data may be used to update statistical models and configurations with new data from system-wide monitoring and analysis to improve precision and accuracy of health monitoring. Processor 110 may be configured to generate a data analytic model relating to the business process. In various embodiments, processor 110 may receive previous health monitoring data from process verification module 150 and/or health analysis module 160. Processor 110 may be configured to generate the data analytic model based on previous health monitoring data relating to the business process. In this regard, the data analytic model may be configured to represent the perfect (or desired) health of the business process end-to-end (or any portion thereof), at every step (or subset of steps) of the process. The data analytic model may provide capabilities to analyze data while the system is running, and in response to new data being generated, by mapping system components and relationships between data sources, observing and measuring data behavior, and/or exploring and analyzing the data to uncover new insights.

In various embodiments, processor 110 may comprise any suitable application, software, system, and/or tools capable of analyzing and/or reviewing the health monitoring data, and generating the data analytic model. Processor 110 may provide analytical capabilities such as statistical models, predictive analytics, dynamic views, and/or the like. The data analytic model may comprise any suitable statistical, predictive, and/or analytical model. For example, the data analytic model may comprise descriptive statistic models, focused on the development of key elements such as the mean, standard, deviation, median, and/or the like. The data analytic model may also comprise inferential statistics models, focused on drawing conclusions from data (such as the health monitoring data), subject to random variation. The data analytic model may also comprise analytical and/or mathematical models focused on event anomalies detected through a mathematical analytic approach. The data analytic model may also comprise predictive models focused on data mining extraction used to predict trends and behavior patterns.

In various embodiments, processor 110 may be configured to check the process accuracy of the health monitoring task and to detect the presence of a system anomaly. Processor 110 may detect the presence of the system anomaly by comparing the health monitoring data to the data analytics model. The health monitoring data may be compared to the data analytics model by correlating the health monitoring data from the various data sources to determine the outcome of the executed business process. This outcome may be compared against various criteria, such as a known, pre-defined business event and/or a rule or regulation (e.g., federal/state laws and regulations). The system anomaly may be an error, and/or the like, in the process, representing an event in the business process that should not have occurred.

In various embodiments, processor 110 may also be configured to generate a health monitoring alert. Processor 110 may be configured to generate the health monitoring alert when the system anomaly is detected. The health monitoring alert may be sent by processor 110 to processor verification module 150, and/or to any suitable party, system, application, and/or the like. Health analysis module 160 and/or process verification module 150 may be configured to monitor and receive the health monitoring alert, and may function as a queue wherein the health monitoring alert is triaged. For example, if the system anomaly was related to a technological error (i.e., an incorrect coding in a software program), the health analysis module 160 and/or process verification module 150 may send the health monitoring alert to a technology team. If the system anomaly was related to a business error, the health monitoring alert may be sent to a business group. The health analysis module 160 and/or process verification module 150 may be configured to receive the health monitoring alerts, and to research into the error and/or problem in the business process that caused the alert.

In various embodiments, health monitoring module 120 may be configured to monitor various data sources 130 related to the business process, and retrieve and store data from those data sources 130. Health monitoring module 120 may comprise any suitable application, system, and/or module capable of monitoring and retrieving data from data source 130, and storing the data in health monitoring database 140. Health monitoring module 120 may be in constant communication with data source 130 such that health monitoring module 120 may be constantly retrieving data from data source 130 and storing the data in health monitoring database 140. Health monitoring module 120 may be in electronic and/or operative communication with processor 110, data source 130, and/or health monitoring database 140. Health monitoring module 120 may be in electronic and/or operative communication using any suitable method discussed in this disclosure or known in the art.

In various embodiments, data source 130 may comprise any source of data relating to the business process. Data source 130 may comprise the health monitoring data from any suitable application, system, and/or the like. The health monitoring data may comprise any data relating to the business process. Data source 130 may be in electronic and/or operative communication with health monitoring module 120. Data source 130 may be in electronic and/or operative communication using any suitable method discussed in this disclosure or known in the art.

Data source 130 may be selected by the entity in response to the identification of the business process. In this regard, the entity may input and select data source 130 that it wants to monitor for the business process. For example (and using the previous example of the entity as a financial institution wherein the business process is posting merchant credits to a financial account), data source 130 may comprise related systems and applications, such as, a merchant submission system, a settlement database, an accounts receivable database, and/or the like. Data source 130 may therefore comprise any related system and/or application that may comprise data related to the business process. Data source 130 may also be selected by health monitoring module 120. In this regard, health monitoring module 120 may identify and automatically select data source 130 that is related to the business process.

In various embodiments, health monitoring database 140 may be configured to store and maintain data. Health monitoring database 140 may store and maintain the health monitoring data from data source 130, the health monitoring alert, and/or any other suitable or desired data. Health monitoring database 140 may store the data relating to each business process separately. For example, health monitoring database 140 may store the health monitoring data and the health monitoring alert as a group, under the related business process. Health monitoring database 140 may store the data in any suitable form, and using any suitable technique. Health monitoring database 140 may be in electronic and/or operative communication with processor 110, health monitoring module 120, and/or process verification module 150. Health monitoring database 140 may be in electronic and/or operative communication using any suitable method discussed in this disclosure or known in the art.

In various embodiments, and with reference to FIG. 1B, the connection between health monitoring module 120 and health monitoring database 140 in system 100 may additionally comprise a data encryption module 122, a data transformation module 124, and/or a data catalog module 126. Data encryption module 122, data transformation module 124, and data catalog module 126 may be configured in a bus, wherein each module may be in operative and/or electronic communication with each other. Data encryption module 122, data transformation module 124, and data catalog module 126 may each separately be in operative and/or electronic communication with health monitoring module 120 and/or health monitoring database 140. Data encryption module 122, data transformation module 124, and data catalog module 126 may be in electronic and/or operative communication using any suitable method discussed in this disclosure or known in the art.

In various embodiments, data encryption module 122 may be configured to encrypt the health monitoring data before the health monitoring data is stored in health monitoring database 140. Similarly, data encryption module 122 may be configured to decrypt the health monitoring data before the health monitoring data is sent to processor 110, health analysis module 160, and/or process verification module 150. Data encryption module 122 may encrypt and/or decrypt the health monitoring data by way of any of the techniques now available in the art or which may become available—e.g., Twofish, RSA, El Gamal, Schorr signature, DSA, PGP, PM, GPG (GnuPG), and symmetric and asymmetric cryptosystems.

In various embodiments, data transformation module 124 may be configured to parse the health monitoring data into a format that may be stored by health monitoring database 140. Data transformation module 124 may also be configured to parse the health monitoring data into a format allowing analysis by processor 110. Data transformation module 124 may parse the health monitoring data using any suitable method described in this disclosure or otherwise known in the art.

In various embodiments, data catalog module 126 may be configured to index the health monitoring data before the health monitoring data is stored in health monitoring database 140. Data catalog module 126 may be configured to index the health monitoring data to speed up the storage and retrieval of the health monitoring data into health monitoring database 140. Data catalog module 126 may also be configured to speed up the retrieval and analysis of the health monitoring data during analysis. Data catalog module 126 may index the health monitoring data using any suitable method, including any method discussed in this disclosure and/or known in the art. Data catalog module 126 may also be configured for load balancing, to further speed up the retrieval and analysis of the health monitoring data.

In various embodiments, and with reference again to FIG. 1A, process verification module 150 may be configured to receive the health monitoring data and the health monitoring alert from processor 110. Process verification module 150 may be configured to receive the health monitoring alert from processor 110 in response to the detection of the system anomaly. Process verification module 150 may be configured to monitor and receive the health monitoring alerts, and may function as a queue wherein the health monitoring alert is triaged. Process verification module 150 may be configured to verify and check the health of the business process, and to provide reporting capabilities. Process verification module 150 may be in electronic and/or operative communication with processor 110, health monitoring database 140, and/or health analysis module 160. Process verification module 150 may be in electronic and/or operative communication using any suitable method discussed in this disclosure or known in the art.

In various embodiments, process verification module 150 may be configured to analyze and research into the system anomaly, and to research into the error and/or problem in the business process that caused the alert. Process verification module 150 may be configured to generate a health monitoring report based on the comparison of the data analytic model to the health monitoring data. In this regard, the health monitoring report may comprise data regarding the overall health of the business process. The health monitoring report may comprise the system anomalies detected by the process verification module 150. The health monitoring report may also comprise additional details related to the system anomalies, such as, for example, the part of the process wherein the system anomaly is occurring, data trends outside of the predicted data trends, monitored data points outside of tolerance levels, spikes and/or valleys falling outside of predetermined thresholds, and/or the like. In various embodiments, process verification module 150 may be configured to transmit the health monitoring report to health analysis module 160 for further analysis.

In various embodiments, process verification module 150 may also be configured to send data about the health monitoring alert back to processor 110. For example, process verification module 150 may send data relating to optimization of the data analytics model, or optimization of various system components and configurations. In this regard, process verification module 150 may be configured, and function as, a feedback mechanism wherein process verification module 150 reports back to processor 110 the current health of system 100.

In various embodiments, process verification module 150 may also be configured to certify the health monitoring task by determining whether the health monitoring task possesses proper qualifications and meets required standards. Process verification module 150 may certify the health monitoring task by analyzing the system anomaly to determine whether the system anomaly is breaking any required standards. The required standards may be set by an entity during selection of the health monitoring event. As an example, where the health monitoring task relates to a business process requiring a regulatory and/or government requirement, the health monitoring task may be certified by analyzing the health monitoring report to determine whether the health monitoring task is in compliance

In various embodiments, health analysis module 160 may be configured to receive the health monitoring alert from process verification module 150. Health analysis module 160 may receive the health monitoring alert, and triage and manage the health monitoring alert for investigation. Health analysis module 160 may comprise any suitable application, software, system, and/or tools capable of receiving the health monitoring data from process verification module 150, analyzing and/or reviewing the health monitoring data, and generating the data analytic model. Health analysis module 160 may be in electronic and/or operative communication with processor 110 and/or process verification module 150. Health analysis module 160 may be in electronic and/or operative communication using any suitable method discussed in this disclosure or known in the art.

In various embodiments, health analysis module 160 may also be configured to send data about the health monitoring alert to processor 110. For example, health analysis module 160 may send data relating to optimization of the data analytics model, or optimization of various system components and configurations. In this regard, health analysis module 160 may be configured, and function as, a feedback mechanism wherein health analysis module 160 reports back to processor 110 the current health of system 100. In various embodiments, processor 110 may be configured to display the data on the current health of system 100, such as through a dashboard or the like. Health analysis module 160 may also be configured send the health monitoring alert, and data related to the health monitoring alert, to a business management group or a technology team for resolution. For example, in response to the health monitoring alert being related to a technological error (i.e., an incorrect coding in a software program), health analysis module 160 may send the health monitoring alert to a technology team. In response to the system anomaly being related to a business error, the health monitoring alert may be sent to a business management group.

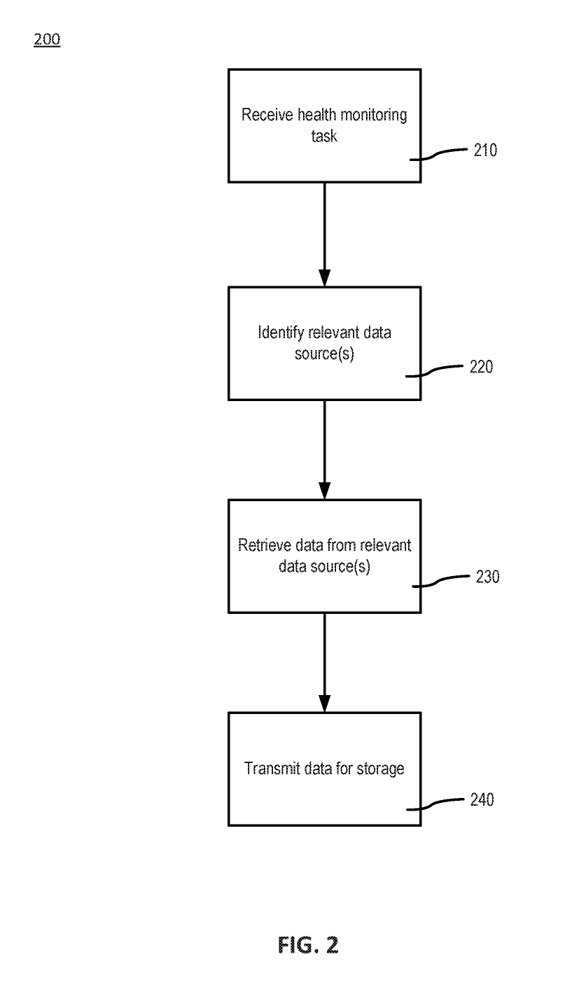

In various embodiments, and with reference to FIG. 2, a method 200 for monitoring a health monitoring task is provided. Method 200 may comprise receiving a health monitoring task (Step 210). The health monitoring task may be input by an entity into a computer-based system, and received by processor 110. The health monitoring task may comprise any business process that the entity desires to monitor. For example, if the entity was a financial institution, the entity may choose to monitor any type of financial transaction business process. As a further example, if the entity was a ride-sharing service such as those provided by Uber Technologies, Inc., Lyft, Inc., and/or other such similar ride-sharing services, the entity may wish to monitor a business process wherein a person requests a car to pick them up. The health monitoring task may comprise any suitable business process.

In various embodiments, method 200 may comprise identifying relevant data sources (Step 220). The health monitoring task may comprise data source 130 that need to be monitored for the health monitoring task. In this regard, the entity may enter into the computer-based system the individual data sources that need to be monitored. With reference to the above example involving a financial institution, the entity may wish to monitor data sources such as accounts receivable database, settlement databases, merchant interfaces, and/or the like. In various embodiments, processor 110 may also be configured to automatically detect data source 130 that needs to be monitored for the health monitoring task. Here, an entity may not have to manually enter data source 130 to be monitored. Instead, processor 110 may analyze the health monitoring task and determine which data source 130 would need to be monitored in order to fully monitor the health of that business process.

In various embodiments, method 200 may comprise retrieving health monitoring data from relevant data sources (Step 230). Processor 110 may be configured to communicate with health monitoring module 120 to monitor the specified data source 130. Health monitoring module 120 may communicate with data source 130 and retrieve data. Health monitoring module 120 may be configured to retrieve all health monitoring data from data source 130. Health monitoring module 120 may retrieve the health monitoring data at any time frequency interval (real-time, near real-time, batch, etc.), and over a constant and consistent period of time.

In various embodiments, method 200 may comprise transmitting the health monitoring data for storage (Step 240). Health monitoring module 120 may be configured to transmit the health monitoring data for storage. The health monitoring data may be transmitted and stored in health monitoring database 140. Health monitoring module 120 may transmit the health monitoring data in any suitable format, and using any suitable method discussed in this disclosure and/or known in the art.

In various embodiments, health monitoring module 120 may transmit the health monitoring data to data encryption module 122, data transformation module 124, and/or data catalog module 126, prior to transmitting the health monitoring data to health monitoring database 140. Health monitoring module 120 may transmit the health monitoring data to data encryption module 122 to encrypt the health monitoring data. Transmitting the health monitoring data to data encryption module 122 prior to health monitoring database 140 may be especially important in response to the health monitoring data comprising any sensitive and/or regulated types of information. Health monitoring module 120 may transmit the health monitoring data to data transformation module 124 to parse the health monitoring data into a format that may be readable by health analysis module 160. Health monitoring module 120 may transmit the health monitoring data to data catalog module 126 to index, catalog, and/or load balance the health monitoring data prior to the transmission to health monitoring database. Data catalog module 126 may be used as a mechanism to speed up the access to the health monitoring data in the health monitoring database 140.

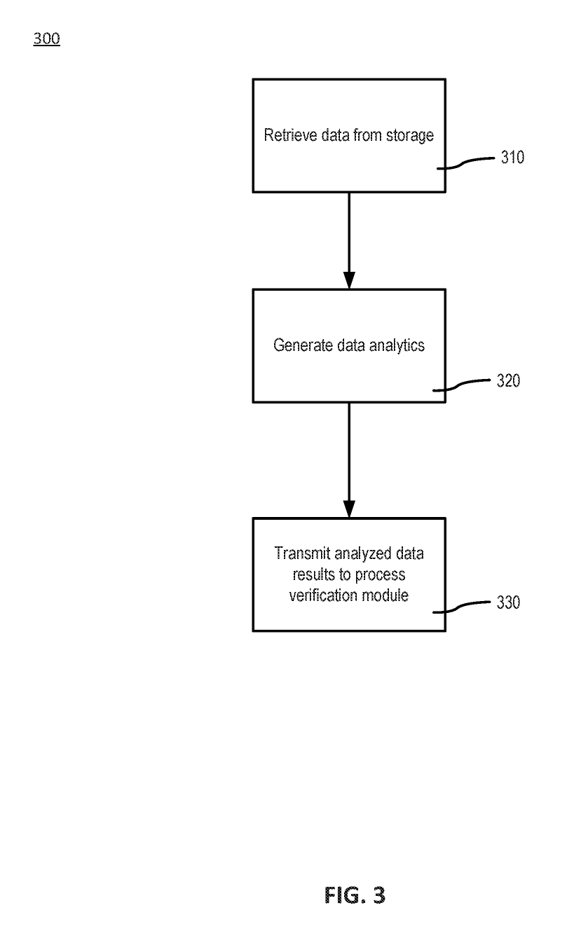

In various embodiments, and with reference to FIG. 3, a method 300 for analyzing health monitoring data is provided. Method 300 may comprise retrieving data from storage (Step 310). Processor 110 may operatively communicate with health monitoring module 120 to retrieve the health monitoring data. Health monitoring module 120 may retrieve the health monitoring data from health monitoring database 140, and may transmit the health monitoring data to processor 110. Processor 110 may also operatively communicate with health monitoring database 140 to retrieve the health monitoring data.

In various embodiments, method 300 may comprise generating a data analytic model (Step 320). Processor 110 may be configured to generate a data analytic model relating to the business process. Processor 110 may generate the data analytic model by analyzing the health monitoring data relating to the business process. Processor 110 may also be configured to receive the health monitoring data from process verification module 150 and/or health analysis module 160, and update the data analytic model by analyzing the health monitoring data relating to the business process. Processor 110 may generate analytical capabilities such as statistical models, predictive analytics, dynamic views, and/or the like. The data analytic model may comprise any suitable statistical, predictive, and/or analytical model. For example, the data analytic model may comprise descriptive statistic models, focused on the development of key elements such as the mean, standard, deviation, median, and/or the like. The data analytic model may also comprise inferential statistics models, focused on drawing conclusions from data (such as the health monitoring data), subject to random variation. The data analytic model may also comprise analytical and/or mathematical models focused on event anomalies detected through a mathematical analytic approach. The data analytic model may also comprise predictive models focused on data mining extraction used to predict trends and behavior patterns.

In various embodiments, method 300 may comprise transmitting the analysis results to process verification module 150 (Step 330). Processor 110 may transmit the analysis results to process verification module 150. Processor 110 may transmit the analysis results using any suitable method discussed in this disclosure, and/or known in the art.

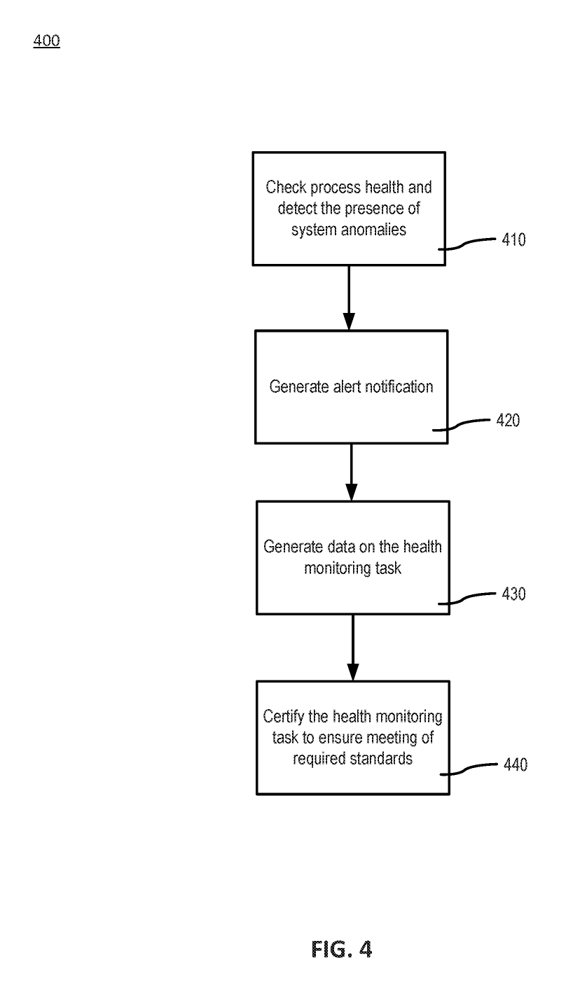

In various embodiments, and with reference to FIG. 4, a method 400 for the health monitoring of systems and applications is disclosed. Method 400 may comprise checking the health of the business process and detecting the presence of system anomalies (Step 410). Processor 110 may be configured to check the health of the business process and to detect the presence of system anomalies. Processor 110 may detect the presence of system anomalies by comparing the health monitoring data to the data analytics model. The system anomaly may be an error, and/or the like, in the process, representing an event in the business process that was not expected to occur. The health monitoring data may be compared to the data analytics model by correlating the health monitoring data from the various data sources to determine the outcome of the executed business process. This outcome may be compared against various criteria, such as a known, pre-defined business event and/or a rule or regulation (e.g., federal/state laws and regulations).

In various embodiments, method 400 may comprise generating an alert notification (Step 420). In this regard, Step 420 may provide notification capabilities to alert the entity regarding detected anomalies and to help avoid future and/or contingent issues related to the anomalies. Processor 110 may operatively communicate with process verification module 150 to generate an alert notification. In response to processor 110 detecting an anomaly and/or determining a problem in the business process, processor 110 may be configured to generate the alert notification. The alert notification may comprise a health monitoring alert. The health monitoring alert may comprise any suitable data regarding the anomaly and/or problem. For example, the health monitoring alert may comprise the data source that the anomaly and/or problem came from, what step in the business process the anomaly and/or problem occurred in, etc. Processor 110 may transmit the health monitoring alert to process verification module 150, and/or any suitable system, person, entity, and/or group configured to receive the health monitoring alert. Health analysis module 160 and/or process verification module 150 may be configured to monitor and receive the health monitoring alerts, and may function as a queue wherein the health monitoring alert is triaged. Health analysis module 160 and/or process verification module 150 may be configured to receive the health monitoring alerts, and to research into the error and/or problem in the business process that caused the alert.

In various embodiments, method 400 may comprise generating a health monitoring report based on the health monitoring task (Step 430). In this regard, the health monitoring report may provide capabilities to highlight and/or discover new business process related facts and help build enhanced machine learning and/or statistical predictive models. Processor 110 may operatively communicate with process verification module 150 to generate the health monitoring report. The health monitoring report may comprise data regarding the overall health of the business process. The health monitoring report may comprise the system anomalies detected by the process verification module 150. The health monitoring report may also comprise additional details related to the system anomalies, such as, for example, the part of the process wherein the system anomaly is occurring, the system failing and/or causing the area, and/or the like. For example, the health monitoring report may comprise a process capability score, a process capability index, a process performance score, a process performance index, and/or any other suitable calculations and reports. The process capability score may comprise a simple indicator of process capability, such as, for example, the number of defects calculated per the process. The process capability index may comprise the process capability score, adjusted for the effect of non-centered distribution. The process performance score may comprise a simple indicator of process performance. The processor performance index may comprise the process performance score, adjusted for the effect of non-centered distribution.

In various embodiments, method 400 may comprise certifying the health monitoring task to ensure that the task is meeting the required standards (Step 440). In this regard, Step 440 may provide the entity the ability to determine if the health monitoring task possesses proper qualifications and meets required standards. Step 440 may be done while the health monitoring task is running. Processor 110 may operatively communicate with process verification module 150 to certify the health monitoring task. Process verification module 150 may be configured to certify the health monitoring task by determining whether the health monitoring task possesses proper qualifications and meets required standards. For example, the health monitoring task may be certified based on business defined events, configured analytical models, and/or any other suitable analytical need. Process verification module 150 may certify the health monitoring task by analyzing the system anomaly to determine whether the system anomaly is breaking any required standards. The required standards may be set by an entity during selection of the health monitoring event. As an example, where the health monitoring task relates to a business process requiring a regulatory and/or government requirement, the health monitoring task may be certified by analyzing the health monitoring report to determine whether the health monitoring task is in compliance.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. A transaction may, in various embodiments, be performed by a one or more members using a transaction account, such as a transaction account associated with a gift card, a debit card, a credit card, and the like. A ROC may, in addition, contain details such as location, merchant name or identifier, transaction amount, transaction date, account number, account security pin or code, account expiry date, and the like for the transaction.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise a merchant website, a social media website, affiliate or partner websites, an external vendor, a mobile device communication, social media network and/or location based service. Distribution channels may include a merchant website, a social media site, affiliate or partner websites, an external vendor, and/or a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and/or the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive . As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB

SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, UNIX® OS, LINUX® OS, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a method of communication, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

As used herein, the term “end user”, “consumer”, “customer”, “cardmember”, “business”, “merchant”, or “financial institution” may be used interchangeably with each other, and each shall mean any person, entity, government organization, business, machine, hardware, and/or software,. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who may complete the payment transaction. In response to the verification being denied, the payment processor relays the information to the merchant, who may decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
identifying, by a processor of a computer-based system in electronic communication with a health monitoring module, a health monitoring task,
wherein the health monitoring task specifies a data source,
monitoring, by the processor and via the health monitoring module, the data source;
retrieving, by the processor, a health monitoring data from the data source;
generating, by the processor and via a health analysis module, a data analytic model,
wherein the data analytic model is based on the health monitoring task;
comparing, by the processor, the data analytic model to the health monitoring data; and
determining, by the processor and based on the comparing, a health of the health monitoring task.

2. The method of claim 1, further comprising transmitting, by the processor, the health monitoring data to a health monitoring database.

3. The method of claim 2, further comprising cataloging, by the processor and via a data catalog module, the health monitoring data in the health monitoring database.

4. The method of claim 1, further comprising generating, by the processor, a health monitoring alert in response to the comparing the data analytic model to the health monitoring data yielding an anomaly.

5. The method of claim 1, further comprising generating, by the processor and via a process verification module, a health monitoring report based on the comparison of the data analytic model to the health monitoring data.

6. The method of claim 5, further comprising certifying, by the processor in response to and contemporaneously with generating the health monitoring report, the health monitoring task by comparing the health monitoring report and the health monitoring alert to the health monitoring task.

7. The method of claim 5, further comprising, transmitting, by the processor via the process verification module, the health monitoring report to the health analysis module.

8. A system comprising:
a processor,
a tangible, non-transitory memory configured to communicate with the processor,
the tangible, non-transitory memory having instructions stored thereon that, in response to execution by the processor, cause the processor to perform operations comprising:
identifying, by a processor of a computer-based system in electronic communication with a health monitoring module, a health monitoring task,
wherein the health monitoring task specifies a data source;
monitoring, by the processor, the data source;
retrieving, by the processor, a health monitoring data from the data source;
generating, by the processor, a data analytic model,
wherein the data analytic model is based on the health monitoring task; and
comparing, by the processor, the data analytic model to the health monitoring data ; and
determining, by the processor and based on the comparing, a health of the health monitoring task.

9. The system of claim 8, further comprising transmitting, by the processor, the health monitoring data to a health monitoring database.

10. The system of claim 9, further comprising cataloging, by the processor and via a data catalog module, the health monitoring data in the health monitoring database.

11. The system of claim 8, further comprising generating, by the processor, a health monitoring alert in response to the comparing the data analytic model to the health monitoring data yielding an anomaly.

12. The system of claim 8, further comprising generating, by the processor and via a process verification module, a health monitoring report based on the comparison of the data analytic model to the health monitoring data.

13. The system of claim 12, further comprising certifying, by the processor in response to and contemporaneously with generating the health monitoring report, the health monitoring task by comparing the health monitoring report and the health monitoring alert to the health monitoring task.

14. The system of claim 12, further comprising transmitting, by the processor and via the process verification module, the health monitoring report to the health analysis module.

15. An article of manufacture including a non-transitory, tangible computer readable storage medium having instructions stored thereon that, in response to execution by a computer-based system, cause the computer-based system to perform operations comprising:
identifying, by a processor of a computer-based system in electronic communication with a health monitoring module, a health monitoring task,
wherein the health monitoring task specifies a data source;
monitoring, by the processor, the source;
retrieving, by the processor, a health monitoring data from the data source;
generating, by the processor, a data analytic model,
wherein the data analytic model is based on the health monitoring task; and
comparing, by the processor, the data analytic model to the health monitoring data ; and
determining, by the processor and based on the comparing, a health of the health monitoring task.

16. The article of manufacture of claim 15, further comprising transmitting, by the processor, the health monitoring data to a health monitoring database.

17. The article of manufacture of claim 16, further comprising cataloging, by the processor and via a data catalog module, the health monitoring data in the health monitoring database.

18. The article of manufacture of claim 15, further comprising generating, by the processor, a health monitoring alert in response to the comparing the data analytic model to the health monitoring data yielding an anomaly.

19. The article of manufacture of claim 15, further comprising generating, by the processor and via a process verification module, a health monitoring report based on the comparison of the data analytic model to the health monitoring data.

20. The article of manufacture of claim 19, further comprising:
certifying, by the processor in response to and contemporaneously with generating the health monitoring report, the health monitoring task by comparing the health monitoring report and the health monitoring alert to the health monitoring task, and
transmitting, by the processor and via the process verification module, the health monitoring report to the health analysis module.
